(19) United States
(12) Patent Application Publication
(10) Pub. No.: US 2020/0342293 A1
(43) Pub. Date: Oct. 29, 2020

(54) QUANTUM COMPUTATIONAL METHOD AND DEVICE

(71) Applicant: INTERNATIONAL BUSINESS MACHINES CORPORATION, ARMONK, NY (US)

(72) Inventors: Peng Liu, Yorktown Heights, NY (US); Shaohan Hu, Yorktown Heights, NY (US); Marco Pistoia, Amawalk, NY (US)

(21) Appl. No.: 16/572,187

(22) Filed: Sep. 16, 2019

Related U.S. Application Data
(60) Provisional application No. 62/837,555, filed on Apr. 23, 2019.

(51) Int. Cl. G06N 3/063; G06N 10/00

(52) U.S. Cl. CPC G06N 3/063; G06N 10/00

(57) ABSTRACT

A quantum computational device includes a plurality n of qubits, each qubit comprising at least two quantum states and having associated therewith 2ⁿ product states. The quantum computational device includes an initialization circuit configured to receive up to 2ⁿ input values and to associate the up to 2ⁿ input values with up to 2ⁿ of the 2ⁿ product states to provide an input vector. The quantum computational device includes a processing circuit configured to communicate with the initialization circuit to receive the input vector and to provide an output value based on the input vector.

### BACKGROUND

The currently claimed embodiments of present invention relate to quantum computers, methods, and executable code, and more specifically, to quantum computers, methods, and executable code to initialize 2ⁿ input values associated with n qubits.

Classical neural networks can apply data with many features, for example, high-dimensional data, such as data having 64 dimensions or greater. The term “classical” here refers to neural networks that are conventional, i.e., not quantum neural networks. Currently, quantum neural networks assign one feature per qubit. NISQ (Noisy Intermediate Scale Quantum) devices may have more than 16 qubits, for example, 50 to 100 qubits. However, with a one-qubit-per-feature approach, NISQ devices can be limited to processing data having at most 50-100 features.

### SUMMARY

According to an embodiment of the present invention, a quantum computational device includes a plurality n of qubits, each qubit comprising at least two quantum states and having associated therewith 2ⁿ product states. The quantum computational device includes an initialization circuit configured to receive up to 2ⁿ input values and to associate the up to 2ⁿ input values with up to 2ⁿ of the 2ⁿ product states to provide an input vector. The quantum computational device includes a processing circuit configured to communicate with the initialization circuit to receive the input vector and to provide an output value based on the input vector.

According to an embodiment of the present invention, a method of performing a quantum computation includes initializing 2ⁿ product states of an n-qubit circuit with up to 2ⁿ input values to provide an input vector, and processing the input vector to provide an output.

According to an embodiment of the present invention, a computer-readable medium comprises code which when executed by a quantum computer causes the quantum computer to: initialize 2ⁿ product states of an n-qubit circuit of the quantum computer with up to 2ⁿ input values to provide an input vector, and process the input vector to provide an output.

### BRIEF DESCRIPTION OF THE DRAWINGS

FIG. 1 is a schematic illustration to help illustrate some concepts of some embodiments of the current invention.

FIG. 2 is a schematic illustration to help illustrate some concepts of some embodiments of the current invention.

FIG. 3 is a schematic illustration contrasting an example of the conventional quantum neural network approach to an embodiment of the current invention.

FIG. 4 is a schematic illustration of an embodiment of the current invention.

FIG. 5 is a schematic illustration to help illustrate some concepts of an embodiment of the current invention compared to a convention quantum neural network.

FIG. 6 is a schematic illustration of some results from the example illustrated in FIG. 5.

FIG. 7 is a flowchart that illustrates a method according to an embodiment of the current invention.

### DETAILED DESCRIPTION

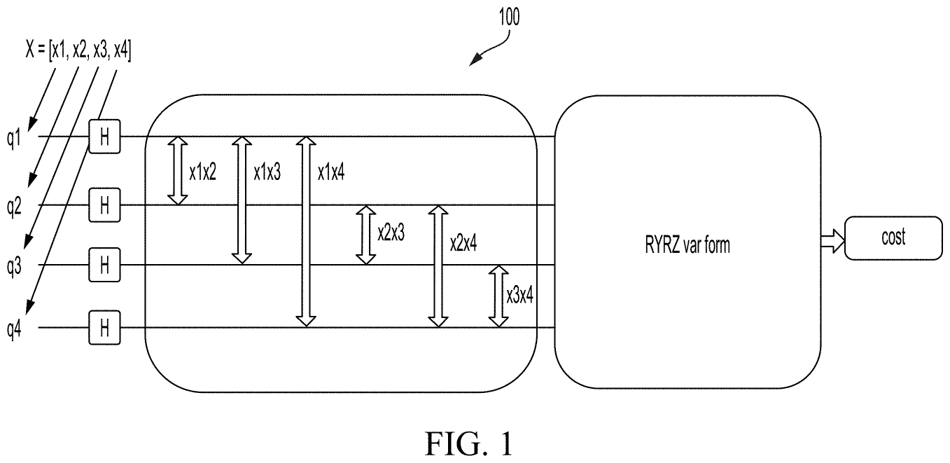

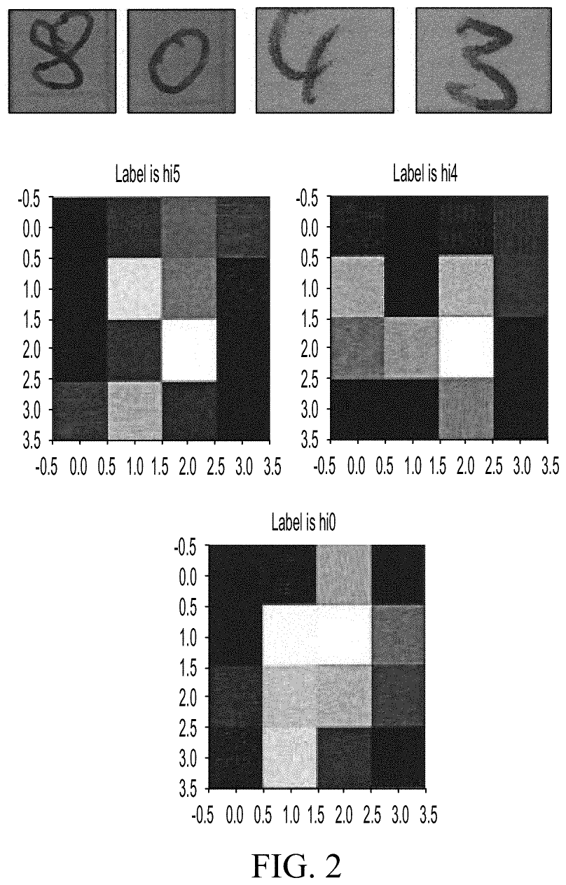

FIG. 1 is a schematic illustration to help illuminate some concepts of some embodiments of the current invention. FIG. 1 illustrates a conventional quantum neural network 100 in which four qubits, q1, q2, q3, and q4 are assigned four features of an input X=[x1, x2, x3, x4]. The one-to-one qubit-to-feature relationship immediately leads to difficulty dealing with the example of image recognition illustrated schematically in FIG. 2. FIG. 2 shows four hand-written Arabic numerals, such as those that might be included in the mnist database often used in classical deep learning. If a classical neural network were used to recognize the numbers in these images, they would likely divide each image into 28*28=784 pixels. If the same problem were to be processed by a quantum neural network in which each pixel were assigned to one qubit, the problem would require 784 qubits. This is a prohibitively large number of qubits, particularly for current NISQ devices.

One possible approach would be to down-sample, for example, reducing 28*28 pixels to 4*4 pixels. This would require 4×4=16 qubits by the conventional quantum neural network approach. However, as one can see in the lower portion of FIG. 2, the images are essentially unrecognizable, even by human intelligence. Down-sampling less, say to 8*8 would already require 64 qubits by the conventional quantum neural network approach.

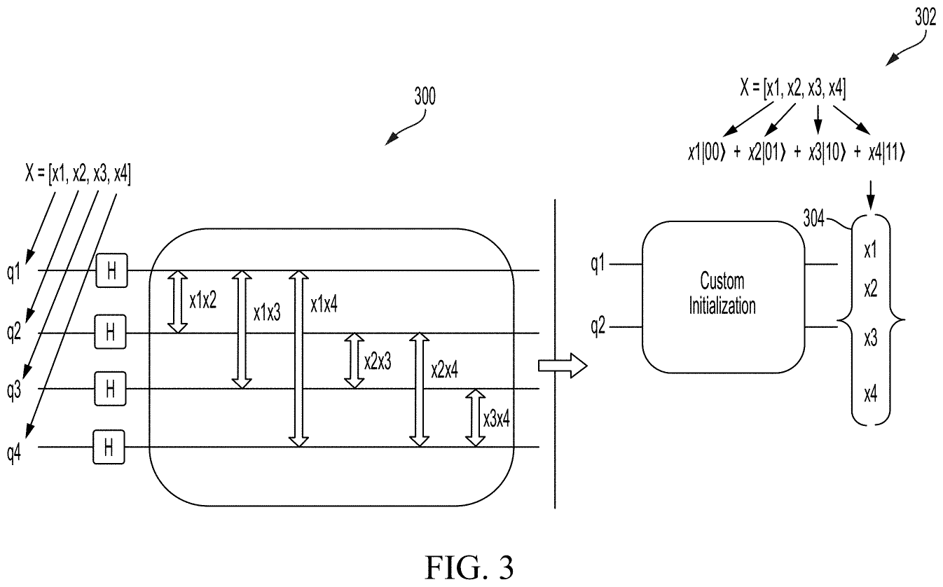

FIG. 3 contrasts an example of the conventional quantum neural network approach 300 to an embodiment 302 of the current invention. The conventional quantum neural network approach includes four qubits, q1, q2 q3 q4, and one feature of the input X is assigned to each qubit. In contrast, the embodiment 302 includes two qubits, q1 and q2. Since each qubit has two states, which we can represent as |0 [symbol] and |1 [symbol] , the two-qubit system has 2²=4 product states: |0 [symbol] |10 [symbol] =|00 [symbol] ; |0 [symbol] |1 [symbol] =|01 [symbol] ; |1 [symbol] |0 [symbol] =|10 [symbol] ; and |1 [symbol] |1 [symbol] =|11 [symbol] . Therefore, an amplitude vector 304 can be formed by assigning each feature to one of the four product states. The general concepts of the current invention are not limited to this particular example. For example, linear combinations of the product states, for example to provide four orthogonal basis states, could alternatively be used. Therefore, in this example, only two qubits are needed according to this embodiment rather than the four required for the conventional quantum neural network.

Using similar notation as above, a three qubit system according to an embodiment of the current invention has product states |000 [symbol] , |001 [symbol] , |010 [symbol] , |011 [symbol] , |100 [symbol] , |101 [symbol] , |110 [symbol] , |111 [symbol] , which is 2³=8 states. In this case, only three qubits are needed for eight features rather than eight qubits according to the conventional approach. More generally, n qubits according to an embodiment of the current invention can accommodate 2ⁿ features. For example, 6 qubits can accommodate 64 features, and 16 qubits can accommodate 65,536 features.

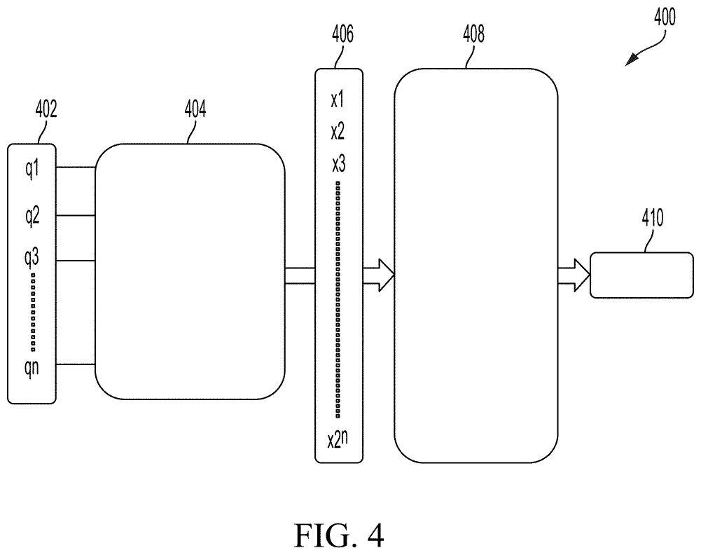

FIG. 4 is a schematic illustration of an embodiment of the current invention. An embodiment of the current invention is directed to a quantum computational device 400 that includes a plurality n of qubits 402, each qubit having at least two quantum states, and the plurality n of qubits 402 having associated therewith 2ⁿ product states. The quantum computational device 400 further includes an initialization circuit 404 configured to receive up to 2ⁿ input values and to associate the up to 2ⁿ input values with up to 2ⁿ of the 2ⁿ product states to provide an input vector 406. The quantum computational device 400 further includes a processing circuit 408 configured to communicate with the initialization circuit 404 to receive the input vector 406 and to provide an output value 410 based on the input vector 406. The general concepts of the current invention are not limited to any particular number n of qubits. In addition, the discussion above and the example in FIG. 4 can be a quantum neural network according to an embodiment of the current invention. However, the general concepts of this invention are not limited only to quantum neural networks.

According to an embodiment of the current invention, the initialization circuit 404 is an input layer of a quantum neural network, and the quantum computational device 400 is the quantum neural network. According to an embodiment of the current invention, the processing circuit 408 is an intermediate layer and an output layer of the quantum neural network. In other embodiments, processing circuit 408 could also include one or more hidden layers of a quantum neural network. The general concepts of a quantum neural network according to some embodiments of the current invention are not limited to any particular number of neural network layers. According to an embodiment of the current invention, the initialization circuit 404 associates each of the up to 2ⁿ input values with a corresponding one product state of the plurality n of qubits 402. According to an embodiment of the current invention, each of the 2ⁿ product states is orthogonal to each other of the 2ⁿ product states.

According to an embodiment of the current invention, the initialization circuit associates each of the up to 2ⁿ input values with a corresponding one of a plurality of linear combinations of the 2ⁿ product states. According to an embodiment of the current invention, each of the plurality of linear combinations is orthogonal to each other of the plurality of linear combinations.

According to an embodiment of the current invention, the quantum computational device 400 includes at least four qubits having associated therewith up to 16 product states. The initialization circuit is configured to receive up to 16 input values and to associate the up to 16 input values with up to 16 of the 16 product states to provide an input vector.

According to an embodiment of the current invention, the quantum computational device 400 includes at least sixteen qubits having associated therewith up to 65,536 product states. The initialization circuit is configured to receive up to 65,536 input values and to associate the up to 65,536 input values with up to 65,536 of the 65,536 product states to provide an input vector.

According to an embodiment of the current invention, each of the 2ⁿ input values corresponds to a feature of a data point having 2ⁿ dimensions.

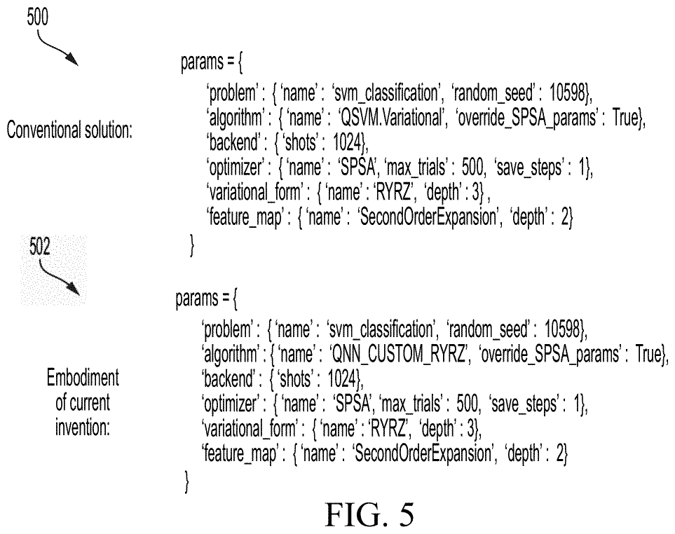

FIG. 5 further illustrates some concepts of an embodiment of the current invention compared to a convention quantum neural network. In FIG. 5, four-dimensional data from the wine dataset is analyzed by a conventional approach 500 and by an embodiment of the current invention 502. The two approaches use similar parameters, for example, depth, training steps, and shots. Although particular computer code is shown as an example, the general concepts of the current invention are not limited to this particular example and type of code.

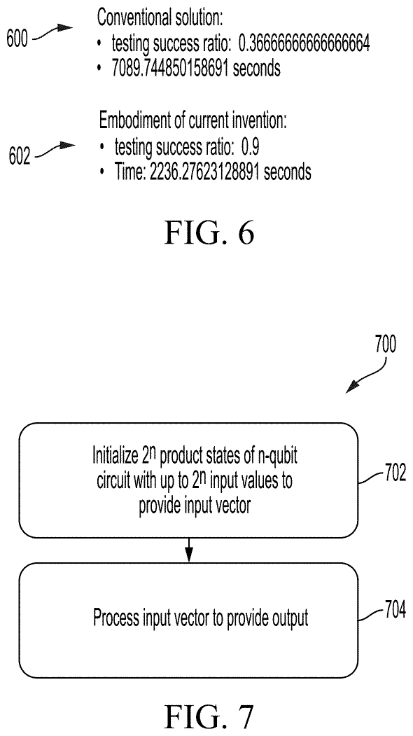

FIG. 6 shows results for the example of FIG. 5. The embodiment of the current invention 602 resulted in a 3× speedup as compared to the conventional approach 600, and was also significantly more accurate (90% vs 36%).

Another embodiment of the current invention is directed to a method of performing a quantum computation. FIG. 7 is a flowchart that illustrates a method 700 according to an embodiment of the current invention. The method 700 includes initializing 2ⁿ product states of an n-qubit circuit with up to 2ⁿ input values to provide an input vector 702, and processing the input vector to provide an output 704.

According to an embodiment of the current invention, initializing includes initializing using an input layer of a quantum neural network. According to an embodiment of the current invention, processing the input vector includes processing the input vector using an intermediate layer and an output layer of the quantum neural network.

According to an embodiment of the current invention, initializing includes associating each of the up to 2ⁿ input values with a corresponding one of the 2ⁿ product states. According to an embodiment of the current invention, each of the 2ⁿ product states is orthogonal to each other of the 2ⁿ product states. Alternatively, initializing may include associating each of the up to 2ⁿ input values with a corresponding one of a plurality of linear combinations of the 2ⁿ product states. Each of the plurality of linear combinations may be orthogonal to each other of the plurality of linear combinations.

Another embodiment of the current invention is directed to a computer-readable medium that includes computer-executable code which when executed by a quantum computer causes the quantum computer to initialize 2ⁿ product states of an n-qubit circuit of the quantum computer with up to 2ⁿ input values to provide an input vector, and process the input vector to provide an output.

According to an embodiment of the current invention, the computer-executable code when read by a computer causes the computer to initialize the 2ⁿ product states by associating each of the up to 2ⁿ input values with a corresponding one of the 2ⁿ product states. Each of the 2ⁿ product states may be orthogonal to each other of the 2ⁿ product states.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A quantum computational device, comprising:
a plurality n of qubits, each qubit comprising at least two quantum states and having associated therewith 2ⁿ product states;
an initialization circuit configured to receive up to 2ⁿ input values and to associate said up to 2ⁿ input values with up to 2ⁿ of said 2ⁿ product states to provide an input vector; and
a processing circuit configured to communicate with said initialization circuit to receive said input vector and to provide an output value based on said input vector.

2. The quantum computational device according to claim 1, wherein said initialization circuit is an input layer of a quantum neural network, said quantum computational device being said quantum neural network.

3. The quantum computational device according to claim 2, wherein said processing circuit is an intermediate layer and an output layer of said quantum neural network.

4. The quantum computational device according to claim 1, wherein said initialization circuit associates each of said up to 2ⁿ input values with a corresponding one product state of said plurality n of qubits.

5. The quantum computational device according to claim 1, wherein each of said 2ⁿ product states is orthogonal to each other of said 2ⁿ product states.

6. The quantum computational device according to claim 1, wherein said initialization circuit associates each of said up to 2ⁿ input values with a corresponding one of a plurality of linear combinations of said 2ⁿ product states.

7. The quantum computational device according to claim 6, wherein each of said plurality of linear combinations is orthogonal to each other of said plurality of linear combinations.

8. The quantum computational device according to claim 1, wherein said plurality n of qubits is at least four qubits having associated therewith up to 16 product states; and
wherein said initialization circuit is configured to receive up to 16 input values and to associate said up to 16 input values with up to 16 of said 16 product states to provide an input vector.

9. The quantum computational device according to claim 1, wherein said plurality n of qubits is at least sixteen qubits having associated therewith up to 65,536 product states; and
wherein said initialization circuit is configured to receive up to 65,536 input values and to associate said up to 65,536 input values with up to 65,536 of said 65,536 product states to provide an input vector.

10. The quantum computational device according to claim 1, wherein each of said 2ⁿ input values corresponds to a feature of a data point having 2ⁿ dimensions.

11. A method of performing a quantum computation, comprising:
initializing 2ⁿ product states of an n-qubit circuit with up to 2ⁿ input values to provide an input vector; and
processing said input vector to provide an output.

12. The method of claim 11, wherein said initializing comprises initializing using an input layer of a quantum neural network.

13. The method of claim 12, wherein processing said input vector comprises processing said input vector using an intermediate layer and an output layer of the quantum neural network.

14. The method of claim 11, wherein said initializing comprises associating each of said up to 2ⁿ input values with a corresponding one of said 2ⁿ product states.

15. The method of claim 11, wherein each of said 2ⁿ product states is orthogonal to each other of said 2ⁿ product states.

16. The method of claim 11, wherein said initializing comprises associating each of said up to 2ⁿ input values with a corresponding one of a plurality of linear combinations of said 2ⁿ product states.

17. The method of claim 16, wherein each of said plurality of linear combinations is orthogonal to each other of said plurality of linear combinations.

18. A computer-readable medium comprising computer-executable code which when executed by a quantum computer causes said quantum computer to:
initialize 2ⁿ product states of an n-qubit circuit of said quantum computer with up to 2ⁿ input values to provide an input vector; and
process said input vector to provide an output.

19. The computer-readable medium comprising computer-executable code according to claim 18, wherein said computer-executable code when read by a computer causes said computer to initialize said 2ⁿ product states by associating each of said up to 2ⁿ input values with a corresponding one of said 2ⁿ product states.

20. The computer-readable medium comprising computer-executable code according to claim 18, wherein each of said 2ⁿ product states is orthogonal to each other of said 2ⁿ product states.
